(19) United States
(12) Patent Application Publication
(10) Pub. No.: US 2004/0258499 A1
(43) Pub. Date: Dec. 23, 2004

(54) Fastener for internal refrigerator/freezer elements

(76) Inventor: Koushik Saha, Brunswick, OH (US)

Correspondence Address: VYTAS R. MATAS, 2412 CEDARWOOD RD., PEPPER PIKE, OH, 44124, US

(21) Appl. No.: 10/463,931

(22) Filed: Jun. 18, 2003

(51) Int. Cl. F16B 13/04

(52) U.S. Cl. 411/32

(57) ABSTRACT

A retainer clip having a rectangular shaped head and body portion with a pair of spaced block members located between two pairs of triangular shaped deformable walls and a pointed end section with the head portion and the pair of block members having aligned apertures for self threading a screw there through to deform said two pairs of triangular shaped wall to thereby capture a member to a wall panel.

### BACKGROUND OF THE INVENTION

1. Field of the Invention

The present invention is generally drawn to element fasteners and more particularly to clips or fasteners used in refrigerators or freezers for retaining internal elements.

2. Description of the Prior Art

Refrigerators and freezers have internal walls to which various elements such as doors, handles ice makers, shelves etc. must be secured. This internal wall has preformed apertures in area where the internal elements are to be fastened which open into a blown insulating foam area located between the internal walls and external walls.

Some presently known clips for retaining the mentioned internal elements are inserted into the preformed apertures prior to the foam insulation being blown into the insulating area. The force of the blown insulation tends to dislodge or move the clip out of position preventing the proper engagement of the internal element. Hence the prior art clips were glued to the internal walls to prevent such dislodgements.

Other types of fasteners were inserted into the foam insulation after the insulation is already blown in. By way of example three different fasteners are described in the following U.S. Patents.

U.S. Pat. No. 4,179,977 teaches a rectangular shaped one piece plastic fastener that is insertable in a rectangular shaped hole in a refrigerator or freezer cabinet panel which accommodates a screw for securing a compartment element in the refrigerator. It has a single central box like structure for retaining a screw mounting the refrigerator element.

U.S. Pat. No. 4,040,463 teaches a circularly shaped one piece plastic fastener that is insertable in a preformed aperture of a refrigerator or freezer cabinet panel and which accommodates a screw for securing a compartment element in the refrigerator. It also has a central box like structure for retaining a screw mounting the refrigerator element.

U.S. Pat. No. 4,648,766 teaches a circularly shaped one piece plastic fastener that is insertable in a preformed circular aperture of a refrigerator or freezer cabinet panel and which accommodates a screw for securing a compartment element in the refrigerator. It has a central structure for retaining a member for mounting the refrigerator element.

None of these fasteners provide both a first deformable wing type structure for securing the refrigerator element and a second deformable wing type structure for retaining the clip in the foam. What was needed was such a two wing fastener or clip which would more positively retain the refrigerator element to the inner panel as well as to the foam insulation.

### SUMMARY OF THE INVENTION

The present invention solves the problems associated with the mentioned prior art devices as well as others by providing a deformable plastic refrigerator or freezer fastener having a rectangular shaped head and a double winged leg extending there from fitting through a preformed aperture in the refrigerator panel to lock the refrigerator element by way of the first wing comprising an angled protuberance on two sides of the clip and to hold itself to the foam by way of the second wing. The clips flat top surface has a hole therein for expanding the first wing to retain a refrigerator element such as a door handle, ice maker, etc. to the user panel. The end of the clip has the second wing element which deforms into the foam to positively hold the clip and refrigerator element.

In view of the foregoing it will be seen that one aspect of the present invention is to provide a refrigerator clip for positively retaining a refrigerator member to both the refrigerator inner panel and the foam insulation behind the panel.

Another aspect is to provide a refrigerator clip having a sharp end for easily piercing the foam insulation behind the refrigerator inner panel.

Still yet another aspect is to provide a refrigerator clip having a pair of deformable wings.

These and other aspects of the present invention will be more fully understood from a review of the following description of the preferred embodiment when considered in conjunction with the drawings.

### BRIEF DESCRIPTION OF THE DRAWINGS

In the drawings wherein:

FIG. 1 is a side perspective view of the refrigerator/freezer clip of the present invention;

FIG. 2 is a top perspective view of the FIG. 1 clip;

FIG. 3 is a cut away side view of the clip of FIG. 1; and

FIG. 4 is a cut away schematic sectional side view of the FIG. 1 clip mounted in the refrigerator to retain a refrigerator member.

### DESCRIPTION OF THE PREFERRED EMBODIMENT

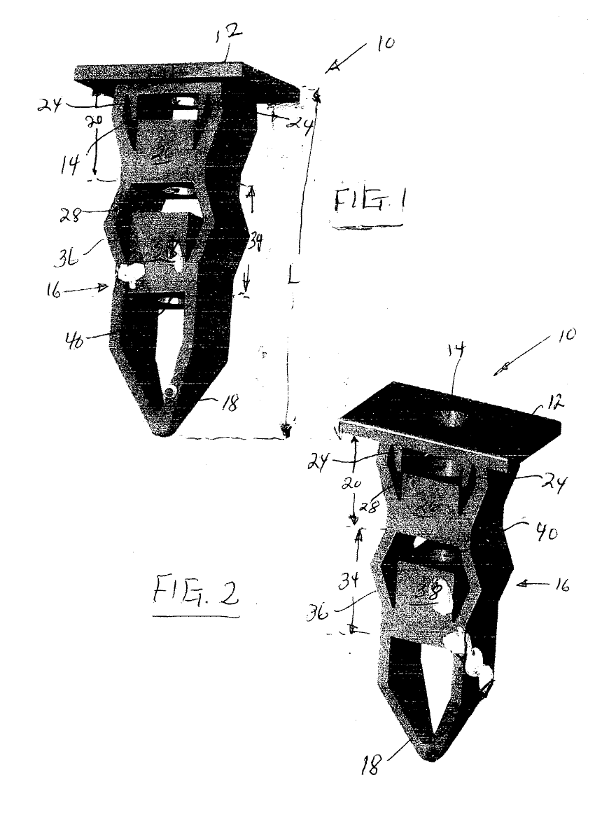

Referring now to the drawings wherein the showing are for purposes of illustrating a preferred embodiment of the present invention and are not intended to limit it thereto, FIGS. 1-3 show a deformable refrigerator clip (10) made from an Acetal deformable plastic material having a rectangular head portion (12) approximately 0.5 in. by 0.75 in. having a centrally located circular aperture (14) there through approximately 0.180 in. in diameter. The large area of the head portion allows a large contact with the refrigerator member (not shown) to minimize rotation of the clip (10) during assembly. The body (16) of the clip (10) is approximately 1.43 in. in length L in the undeformed position and is substantially rectangular shaped to prevent turning when inserted into the foam between refrigerator or freezer panels.

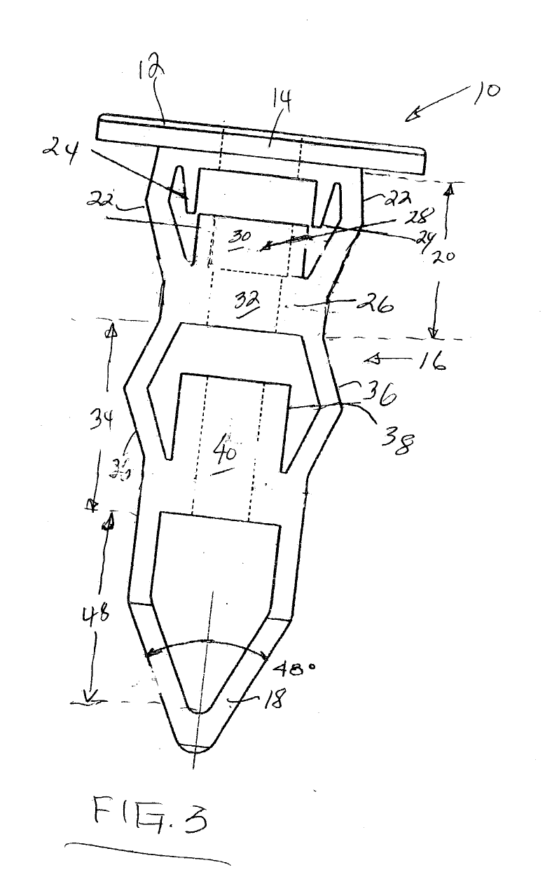

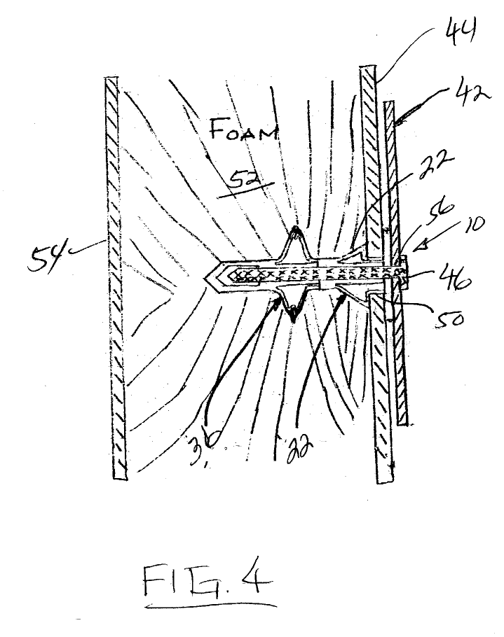

The clip body (16) has a pointed end section (18) forming a triangle of 48° as best shown in FIG. 3. This sharp triangular shape allows easy penetration of the body (16) into the foam insulation preventing “balling” of the foam insulation and reduces clip (10) engagement force. A top section (20) of the body (16) has a first set of triangular shaped deformable walls (22) having a pair of internal fingers (24) formed there from and a first block (26) located between the fingers (24) to be able to fit there between when the walls (22) are expanded out during assembly as will be described later. The block (26) has a slipped circular opening assembly (28) aligned with the aperture (14) comprising a first step (30) the same 0.180 in. diameter as the opening (14) and a second smaller step (32) approximately 0.157 in. in diameter. The clip body (16) also has a middle section (34) having a second set of triangular shaped deformable walls (36) and a second block (38) located there between having a circular opening (40) there through aligned with the opening (32) of the first block (26) but spaced there from. The opening (40) is slightly smaller in diameter (0.130) then the opening (32) but is about twice the depth of the opening (32). The openings (14) and (30) are intended to be larger than the diameter of a self-threading screw intended for mounting the clip (10) and are lead ins for guiding the screw into the self-threading openings (32) and (40). The difference in depths and diameters of (32) and (40) makes the first block (26) strip torque less than the second block (38) providing a higher range of drive torque to strip torque ratio since strip torque is dependant on the amount of thread capture.

Turning now to FIG. 4, the clip (10) is shown in its deformed position mounting a refrigerator member (42) such as an ice maker, shelf or door handle etc. to an inner refrigerator panel (44) using a self-tapping screw (46) such as a #8AB×1 in. length. It will be seen that since the body (16) has a long empty internal section (48), different lengths of screw (46) could be used. In application, the clip (10) is driven through a preformed aperture (50) in the inner panel (44) to extend into the foam (52) blown between the inner panel (44) and an outer panel (54) until the head portion (12) is resting against the panel (44). The screw (46) is now extended through a preformed opening (56) in the refrigerator member (42) and into the guide holes (14) and (30) until it reaches the smaller diameter hole (32). It is now threaded therein causing the first triangular walls (22) to expand outward causing the first block (26) to move up between the fingers (24) until the walls (22 are deformed against the inner panel (44) to securely capture the member (42) between the top (12) of the clip and the first set of walls (22) with the member (42) firmly locked there between as seen in FIG. 4. Further rotation of the self tapping screw (46) encounters the opening (40) and block (38) is moved up toward the opening (32) deforming the second set of walls (36) into the foam (52) to act as a second retainer for the member (42). When the clip (10) is fully deformed, the shaft length L goes from the initial length of 1.37 in. to a deformed length of 1.15 in.

While an application of the clip is shown for refrigerator parts other uses such as for automotive members attachment is also possible. It will be understood that such other applications and modifications have been deleted herein for the sake of conciseness and readability but are fully intended to fall within the scope of the following claims.

I claim:

1. A retaining clip for mounting a member having an aperture to a panel also having an aperture and a foam area being the wall comprising:
a head portion having an aperture therein adopted for holding the member thereon with the member aperture aligned with said head portion aperture; and
a body portion extending from said head portion having a first and second pair of spaced triangular shaped walls adapted for insertion into the foam area behind the panel to retain the member against the panel by deforming the first pair of triangular walls against the inside of the panel and deforming the second set of triangular walls into the foam.

2. A clip as set forth in claim 1 wherein said head portion and said body portion is substantially rectangular in shape to help prevent rotation of the clip in the foam.

3. A clip as set forth in claim 2 including a first block located between said first pair of flexible walls adapted to have a self-threading screw move said first block towards said head portion to deform said first pair of flexible walls against the panel thereby.

4. A clip as set forth in claim 3 including a second block located between said second pair of flexible walls adapted to have a self threading screw move said second block up towards said first block to deform said second pair of flexible walls into the foam thereby.

5. A clip as set forth in claim 4 wherein said body portion includes an angled pointed end section to help the clip body penetrate the form.

6. A clip as set forth in claim 5 wherein said first block is formed to have two step aperture with the first step adapted to guide the screw toward the second aperture used to thread the screw therein.

7. A clip as set forth in claim 6 wherein said second block has an aperture there through approximately the same diameter as the said clip of the first block but twice the length of said second step.

8. A clip as set forth in claim 7 wherein said first block aperture is approximately ½ the length to insure the stripping of said first block prior to said second block.

9. A clip as set forth in claim 7 including a pair of fingers located between said first set of de formable walls adapted to fit said first block there between when the first set of flexible walls are deformed.

10. A clip as set forth in claim 9 including a spaced section between said first and second block to allow said first set of walls to be deformed prior to deforming said second set of walls by first completely threading the second step of said first block aperture prior to threading said second block aperture with said fingers resisting torque whenever a screw is threaded and said first set of deformable walls are collapsing.

11. A clip as set forth in claim 10 including a spaced open section between said second block and said pointed top of said body section to allow different lengths of self-threading screws to be used.

12. A clip as set forth in claim 8 wherein the torque on said first block is less than on said second block to allow a higher range of drive torque to strip torque.

13. A clip as set forth in claim 12 wherein said second set of deformable walls help prevent laminar separation of foam and panel.
